(19) United States
(12) Patent Application Publication
(10) Pub. No.: US 2008/0178224 A1
(43) Pub. Date: Jul. 24, 2008

(54) UPGRADEABLE INTELLIGENT REMOTE CONTROL DEVICE WITH INTEGRATED PROGRAM GUIDE

(76) Inventors: Michael Laude, San Diego, CA (US); Kristen Glass, San Diego, CA (US)

Correspondence Address: MICHAEL LAUDE, 4881 ORCHARD AVE., SAN DIEGO, CA, 92107, US

(21) Appl. No.: 11/625,315

(22) Filed: Jan. 20, 2007

(51) Int. Cl. G06F 3/00; H04N 5/44

(52) U.S. Cl. 725/44; 348/734

(57) ABSTRACT

This patent describes an intelligent, programmable, universal remote control device which can be used by a user to control any device that responds to commands sent via infrared, Bluetooth, or other wireless personal area network technology. The invention includes an integrated program guide that may be updated either manually or automatically from a remote server. The program guide is structured so that it can contain any information about the devices to be controlled, is searchable, and can be customized by the user. For example the program guide may contain information about the channels a device can receive, the programs on each channel, detailed information about each program, and supplemental content for selected programs, including executable and interactive content. The user may search the program guide for desirable programs and may customize the guide to show only those programs or channels that are of interest to the user. The invention can be embodied using existing mobile communications devices, or any programmable device that includes a display, input system, wide area network, for example the Internet, access to remote servers, and wireless local/personal area network access, for example infrared, to devices to be controlled. The invention also allows users to save their settings, preferences, and identification to a remote server and to restore these values from the remote server.

### FIELD OF THE INVENTION

This invention relates to the field of information processing. More particularly, the present invention is a novel and improved universal, programmable, upgradeable, intelligent remote control device with an integrated, updateable, interactive program guide.

### DESCRIPTION OF THE RELATED ART

Many modern devices, for example but not limited to, televisions, video cassette and DVD players/recorders, audio CD players, AM/FM radio receivers, microwave ovens, and garage door openers, are designed for remote operation. Usually, the manufacturer includes a remote control device with the device to be controlled, but there are also numerous providers of after market, universal remote control devices, that can be programmed to control multiple devices. Until recently, most of these devices used infrared to communicate with the devices to be controlled, but Bluetooth and other personal area network technologies are also being used as these technologies become more widely available.

The exact protocol and commands that the remote control device uses to control devices via infrared varies widely from manufacturer to manufacturer, but these interfaces are usually well documented and easy to implement, albeit different for each device. For emerging technologies such as Bluetooth and other personal area networks, the interfaces are still evolving, so a critical feature of this invention is that it is easy to update as new device and interfaces become available.

Until recently, most remote control devices have been relatively simple affairs with limited processing capabilities and little or no display capabilities. However, as mobile phones with internet access, high resolution displays, infrared and Bluetooth connectivity, and powerful, programmable processing capabilities have become widely available, it is now possible to create an intelligent, programmable universal remote control with an integrated, interactive channel guide. Interactive program guides have been available for some time, but until this invention, they have not been integrated into the functions of a portable remote control device. By integrating the remote control and program guide functions, the invention makes possible a whole new generation of interactive audio and audiovisual applications. The invention allows the user to select a program and then interact with the selected program. This invention is an essential component of any interactive audio/video experience.

Access to the Internet or other wide area network is an essential part of this invention: it provides the avenue by which the invention updates itself. As new technologies & devices become available, any universal remote control device which cannot be easily upgraded quickly becomes obsolete and useless.

### SUMMARY OF THE INVENTION

This invention consists of a programmable, intelligent remote control device with an integrated program guide. The invention allows the user to easily control multiple devices, including for example, but not limited to, televisions, video cassette and DVD recorders, radios, microwave ovens, and garage door openers. The invention allows users to select the device they wish to control, download or enter information about the device to be controlled and how to control it, update the invention's internal software, access program schedules and supplementary information, and store user profile information.

The real power of the invention lies in its ability to download up-to-date program information from a remote server and display the information to the user, allowing the user to find programs and content quickly and easily, either for immediate consumption or for later use.

The program guide need not be restricted to audio or audiovisual programming. It could, for example, be a cookbook containing recipes with optimized settings for different cooking devices.

The interactive nature of the program guide and the supplemental information it contains allow the users an unprecedented level of interaction with the programming they select.

Although this invention is particularly well suited for implementation on a mobile communications device, for example a mobile phone, it may be embodied in any programmable device that provides the following features:
(1) Internet or wide area network access
(2) Display with some sort of input device, for example, telephone number pad, keyboard, stylus, touch screen, or other interactive system
(3) Infrared, Bluetooth, or other personal area networking system for interfacing to the devices to be controlled
(4) Downloadable software

### BRIEF DESCRIPTION OF THE DRAWINGS

The nature, objects, and advantages of the invention will become more apparent to those skilled in the art after considering the following detailed description in connection with the accompanying drawings, in which like reference numerals designate like parts throughout, and wherein:

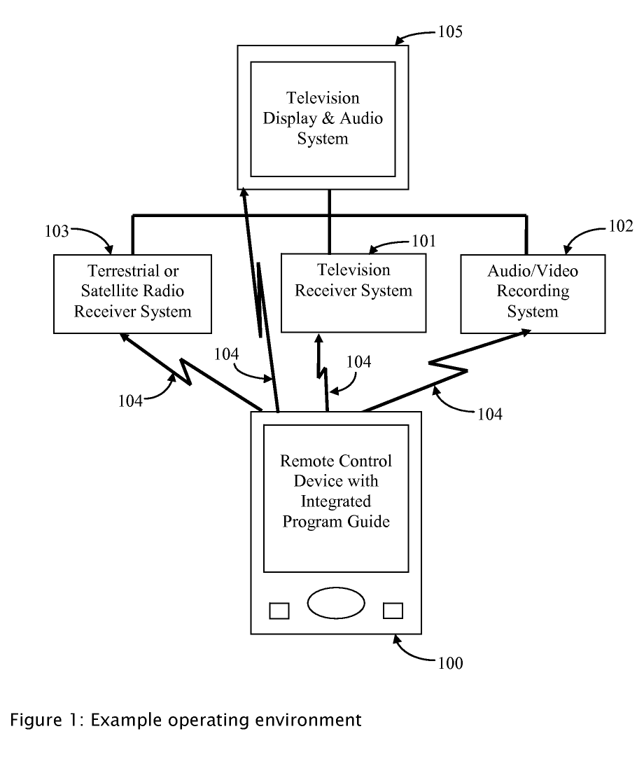

(1) FIG. 1 shows the typical environment in which the invention operates and its relationship to other devices and systems.

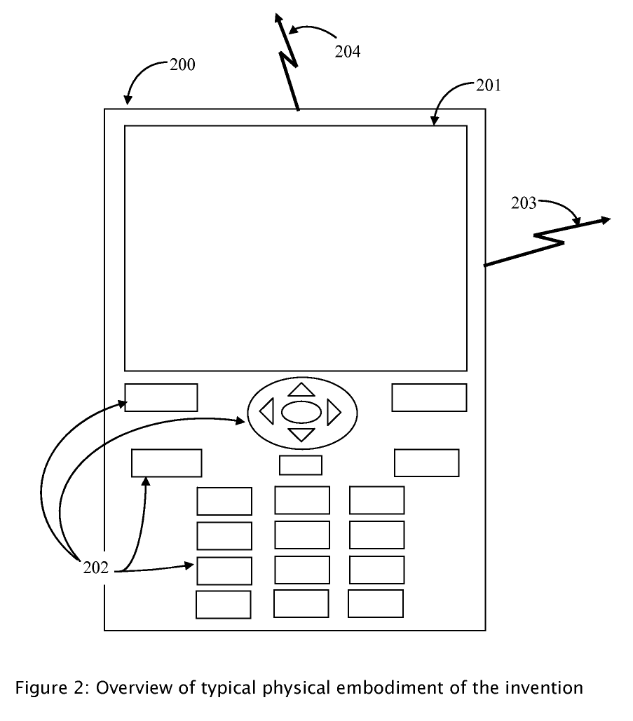

(2) FIG. 2 provides an overview of a typical physical embodiment of the invention.

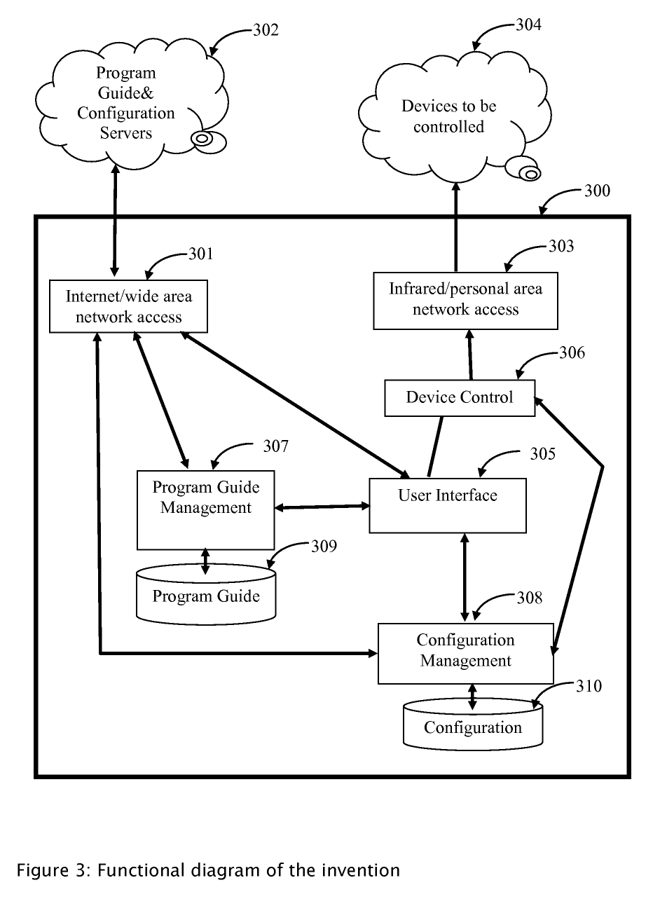

(3) FIG. 3 provides functional diagram of the invention.

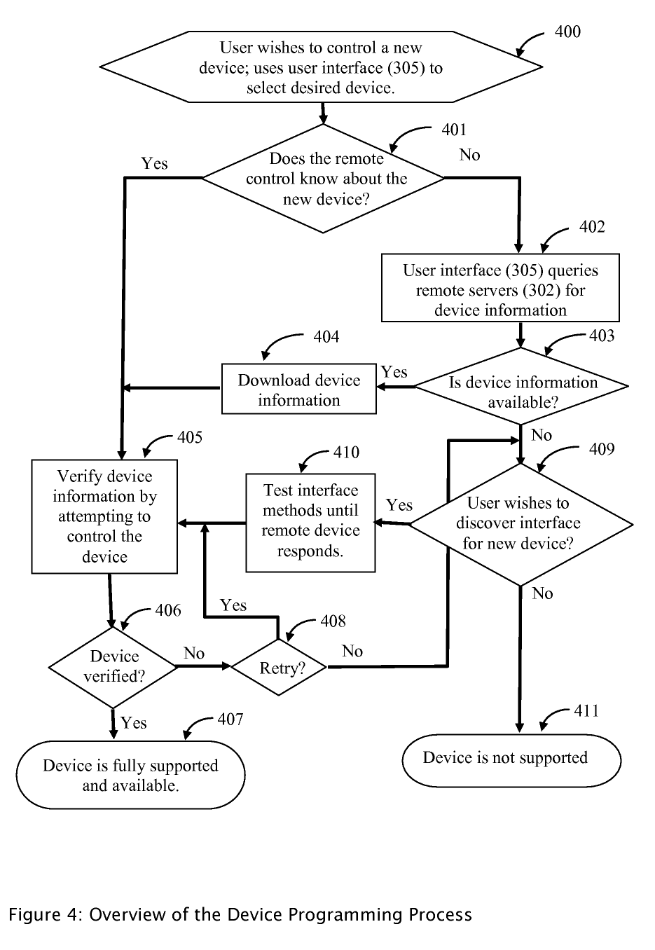

(4) FIG. 4 provides an overview of the device programming process

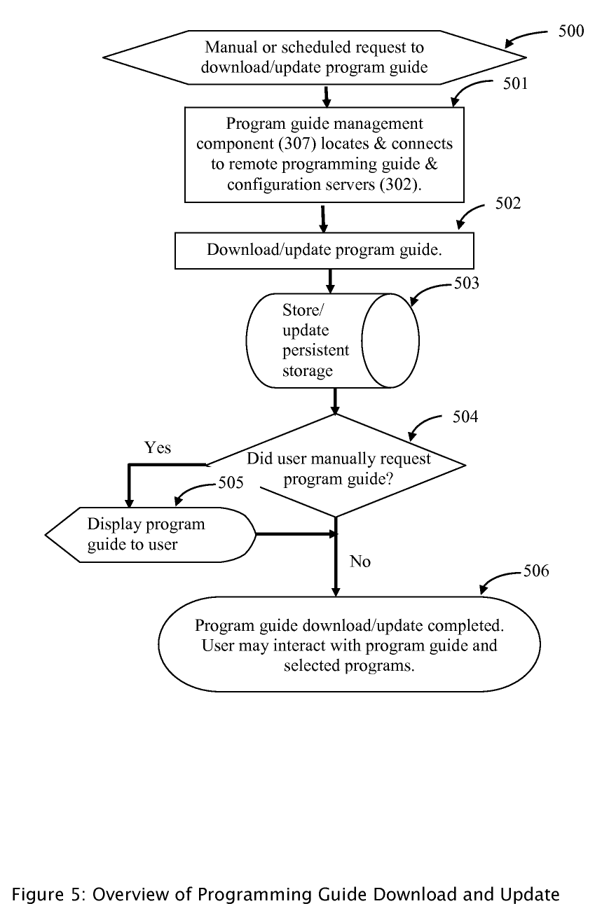

(5) FIG. 5 provides an overview of the process of downloading and updating program guides.

### DETAILED DESCRIPTION OF SELECTED EMBODIMENTS

This section provides detailed descriptions of selected embodiments.

FIG. 1 provides an example of a typical environment in which the invention, a remote control device (100), operates and its relationship to other devices and systems. In this example, the remote control device (100) uses infrared or other personal area network technology (104) to communicate with devices such as a television receiver system (101), an audio/video recording system (102), a terrestrial or satellite radio receiver system (103), directly to a television display and audio system (105) to control functions such as volume and brightness, or other devices with remote control interfaces. In this example, these devices are all connected to a television display and audio system (105), where the selected programming is presented to the user.

FIG. 2 provides an overview of an example embodiment of the invention, a remote control device (200), consisting of a display (201) where the channel guide, programming guide, and other information are presented to the user, an input system (202), consisting, for example, of programmable keys, positioning keys, selection keys, and alphanumeric keys. Other input devices may include, but are not limited to, touch screens, either finger or stylus activated, and voice input systems. The device communicates with the Internet or other wide area network using standard Internet protocols over cellular technologies such as CDMA or GSM, wireless local area networks as described in the IEEE 802.11 family of specifications, Ultra Wide Band (UWB), WiMAX, or other wireless technology (203). The invention (200) communicates with the devices to be controlled using infrared or other personal area network technology (204).

FIG. 3 is a functional diagram of the invention. The invention, an upgradeable, programmable, intelligent remote control device (300) consists of several major functional components. The Internet/wide area network access component (301) is responsible for communications with the program guide and configuration servers (302). It must find the correct servers, provide identification and authentication credentials to the servers, send requests to the servers on behalf of the other components, and receive data from the servers. The user interface component (305) allows the user to search for and select channels and programs, view or use supplemental data to interact with the selected programs, update the integrated program guide, control external devices, save and restore preferences and settings, update or change external device settings, as well as providing access to other remote control and mobile device functions. This component uses the device display (201) to present information to the user and accepts user commands from the input system (202). This component implements user commands by using functions provided by the programming guide management (307), device control (306), and configuration management (308) components. The infrared/personal area network access component (303) is responsible for the interface to the devices to be controlled (304).

The program guide management (307) component is responsible for keeping the program guide (309) up-to-date, based on preferences set via the user interface software component (305). It uses the functions supplied by the Internet/wide area network access component (301) to retrieve program guide updates from the programming guide and configuration servers (302). It also provides the user interface software component (305) with access to the program guide information so that the user interface software can display the guide to the user and respond to user queries.

The configuration management component (308) is responsible for maintaining and providing access to the configuration database (310). This database contains all the important information about the devices that the user wishes or might wish to control. The device control component (306) provides the interface to the devices to be controlled. It uses the functions supplied by the configuration management component (308), which uses the Internet/wide area network access component (301) to retrieve device information from the program guide and configuration servers (302). It also uses the infrared/personal area network access component (303) to send commands to the devices to be controlled (304) on behalf of the user interface software component (305) and the configuration management component (308).

FIG. 4 provides an overview of the device programming process. The process starts when the user decides to use the remote control device to control a new or updated device. The user uses the user interface component (305) to select the desired device (400). The next step depends on whether or not the device appears in the remote control's list of supported devices (401). If the remote control already knows about the device, it attempts to verify its information by sending commands to the device (405). If the commands work (406), the device is fully supported (407) by the remote control device. User input may be required in order to verify that the device to be controlled has responded. If the device verification fails, the user interface component presents the user with several options: retry the verification process (perhaps, for example, after verifying the device to be controlled is turned on), allow the remote control device to try and discover the interface for the new device (409), or abandon the effort, in which case the device cannot be supported by the remote control device (411). If the user selects the discovery option, the device tests interface methods until the remote device responds (410). Once the remote control device finds an interface method that appears to work, it verifies the information by attempting to control the device (406). If the verification process works, the device is fully supported and the user may use the remote control to control the device. Otherwise, the user decides whether to continue or abandon the process.

If the device to be controlled does not appear in the remote control device's list of supported devices, the user interface (305) uses the Internet/wide area network access (301) and device control (306) components (301) to locate and query remote configuration servers (302) for information about the device to be controlled. If servers can supply information on the device, the device control component (306) uses the Internet/wide area network access component (301) to download the device information (404) and the process continues as described above. If the servers cannot provide information on the device, the user may tell the remote control device to attempt to discover the device interface information (as described above).

FIG. 5 provides an overview of the program guide download/update process. Program guide downloads or updates may be either manually requested by the user or may be scheduled by the user or remote control device to occur at pre-selected times or in response to specific events (500). In all cases, the programming guide management component (307) uses the services of the Internet/wide area network access component (301) to locate and connect to the remote programming guide & configuration servers (302) (501). The servers (302) may be configured to allow unauthenticated access or may require that the remote control device authenticate itself. If the servers (302) require authentication, the remote server supplies its authentication credentials. The remote control device may be pre-configured with the correct credentials or the credentials may be supplied by the user. Once the remote control device has successfully connected to the remote servers (302), it either downloads the entire program guide, a complete, customized program guide, or requests an update to its current program guide (502). Once it has successfully downloaded the program guide or program guide update information, the program guide management component (307) stores or updates the program guide information in the remote control device's persistent storage (503). Persistent storage refers to any electronic storage medium which retains its contents even when the remote control device is turned off or its power source (for example, its battery) is disconnected or removed. If the user manually requested the program guide download or update (504), the program guide management component (307) notifies the user interface component (305) that the download or update is complete. The user interface component (305) then displays the program guide to the user (505) & handles any user interaction with the program guide. Otherwise, the up-to-date program guide sits in the remote control device's persistent storage until the user requests access to the guide (506).

### Article of Manufacture

The invention may be implemented as shown in FIGS. 2 and 3. For example, the invention, a remote control device (300), may be embodied as a mobile phone with a personal area network interface, such as infrared, configured with specialized software that downloads configuration and program guide information from a remote server and that allows the user to select programming and control devices such as television receiver and display systems. Here, the term “software” is used broadly and comprises, for example, a machine readable language construct that species an operation and identifies operands (instructions), application programs, algorithms, software configuration data, multimedia data, video data, and audio data. These data may reside in any type of storage unit using any type of data storage media. In various embodiments, the software may comprise or emulate lines of compiled “C-type” or “C++ type” language, “Java-type” interpreted or pre-compiled language, source code, object code, executable machine code, executable programs, data banks, application-specific integrated circuits, or other types of commonly known data.

### Other Embodiments

Despite the specific foregoing descriptions, ordinarily skilled artisans having the benefit of this disclosure will recognize that the apparatus, method, and article of manufacture discussed above may be implemented in an apparatus, system, method, or article of manufacture of different construction without departing from the scope of the invention. Similarly, parallel methods or enhancements may be developed. As a specific method and apparatus example, remote control devices with cameras can detect that a device turns off in response to the appropriate command from the remote control device, thereby verifying that the remote control is using the correct method to communicate with the remote device.

As a specific article of manufacture example, the program guide management component (307) and user interface components may be modified to become more efficient or easy to use, or it may be expanded to include additional functions. The format and content of the program guide, device, and other data may be modified for the sake of efficiency, accuracy, ease of implementation, or to provide additional information.

Another specific article of manufacture example: although the sample embodiment presented above uses a standard mobile communications device, for example a mobile phone, the invention could be embodied in a specialized, custom device without departing from the scope of the invention. For example, although the ability to use the invention to make voice calls enhances the interactive capabilities of the invention, it is not essential to the basic operation, but an embodiment which leaves out a feature, in this example, voice calling, does not depart from the scope of the invention.

What is claimed is:

1. A universal, programmable, upgradeable remote control device with updateable, integrated program guide. The integrated program guide allows the user to quickly and easily identify channels and programs either for immediate viewing or recording for later viewing. The integrated program guide also allows the invention to provide the user with powerful new ways of interacting with audio and audiovisual programs. The device can be upgraded to support new devices, content, and technologies.

2. A unique mechanism for manual and automatic updates of the remote control device. Updates may include programming information, device codes, new interfaces, protocols, commands, and communications methods, and supplemental materials. The supplemental information may be associated with channels, networks, services, devices, or specific programming/content and consist of text, data, audio, video, executable, and other content. Examples of supplemental content might be advertisements or trailers for programs, or interactive programs allowing extensive interaction with audio and audiovisual programs.

3. Manual and automatic backups from the remote control device to a remote server of useful user settings and information, for example, but not limited to
(1) Device, service provider, and subscribed channel/program information
(2) User preferences, for example, favorite programs, channels, play lists, etc.
(3) User settings/defaults for interactive services
(4) User account and charging information

4. Capability of restoring device and user settings for the remote control device from a remote server. The user settings may include subscriber information for various services, for example, satellite television, allowing the user to charge “pay per view” (PPV) and premium services to their home account, even when they are in another location, perhaps on vacation, and using another subscriber's satellite receiver.

5. Use of remote control device using supplemental program guide information to interact with audio/video programs. For example, users may use the supplemental information to play along with their favorite game show, vote for their favorite performer, obtain additional information, send messages to the content providers and performers, etc. Since the remote control device knows which program the user has selected, it can easily provide the user with any supplemental information and services related to the program or content. Also, the supplemental information may direct the remote control to send the user's requests and messages to a specific server for a specific program.
